(19) United States
(12) Patent Application Publication
(10) Pub. No.: US 2005/0096964 A1
(43) Pub. Date: May 5, 2005

(54) Best indicator adaptive forecasting method

(76) Inventor: Roger Yen-Luen Tsai, Yorktown Heights, NY (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/694,737

(22) Filed: Oct. 29, 2003

(51) Int. Cl. G06F 17/60

(52) U.S. Cl. 705/10

(57) ABSTRACT

A Best Indicator Adaptive (BIA) method fuses several singular indicators into one composite model to provide a new forecasting combination scheme. BIA uses the sizes of the spread of the distribution taking into account the variation of the distribution parameters themselves. Underlying the BIA method is the common theme and unifying theory of the power of quotient and the methods of making use of order composition and sales opportunities pipeline progression.

### BACKGROUND OF THE INVENTION

1. Field of the Invention

The present invention generally relates to a computer implemented method of forecasting product demand and, more particularly, to a unifying forecasting framework called “Best Indicator Adaptive” or BIA method which encompasses many individual forecasting systems, each making use of single, double or triple indicators while sharing a central common theoretical foundation as well as a global framework and methodology uniting all the indicators together to produce a final optimum forecast.

2. Background Description

Traditional time series statistical forecasting makes use of only demand history, that is, demand in time periods in the past, and project to the future, assuming that patterns, in the past will repeat in the future. Although some have made attempts to use orders (load) of current time period in making a forecast, none have made use of a variety of information and indicators all related to demand in the current time period such as load, ship, CA (customer accept) history, and exploit the relationships among them in making a forecast. Neither has anyone in the past made use of the aggregated pattern in the dates for the orders to be fulfilled in the future to make a better forecast. Finally, none has a process to adaptively choose the best model among those just described to come up with the final optimum forecast.

### SUMMARY OF THE INVENTION

It is therefore an object of the present invention to provide a unifying forecasting framework which encompasses many individual forecasting systems, each making use of single, double and triple indicators.

According to the invention, the system makes use of four sources of information, creating seven different forecasting models. The adaptive optimization finally makes use of these seven models to produce a final forecast. The invention significantly reduces the forecast error for any given individual indicator or forecasting subsystem.

The four sources of information or indicators are the following:
1. Load or total order (L);
2. Ship (S);
3. CA Quarterly history (CAₕᵢₛₜ); and
4. CRAD (customer requested date) or RSD (requested ship date for the load or orders.
   In the forecasting framework according to the invention, a plurality of forecasting subsystems are incorporated, but only one among the plurality makes use of the information in the past only. In a specific implementation of the invention, seven forecasting subsystems are incorporated. All these seven forecasting methods share the same central fundamental theoretical foundations while each maintains its own uniqueness. A unique capability of the invention is the optimization framework making use of all the seven indicators. This novel and unique capability significantly reduces the forecast error for any given individual indicator or forecasting subsystem.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram showing the overall system in which the invention is implemented;

FIG. 2 is a system flow diagram illustrating the process implemented by the invention;

FIG. 3 is a flow diagram showing the process for the function forecast generation from load (L);

FIG. 4 is a flow diagram showing the process for the function forecast generation from ship (S);

FIGS. 5A and 5B, taken together, are a flow diagram showing the process for the function forecast generation from load and ship (LS);

FIGS. 6A and 6B, taken together, are a flow diagram showing the process for the function CA_{L,CRAD} forecast generation;

FIG. 7 is a flow diagram showing the process for the function of adaptive optimization;

FIG. 8 is a graph showing the relationship between the ratios Load/CA and Ship/Load and a non-BIA forecast;

FIG. 9 is a graph showing the comparison between the BIA's forecast making use of the relationship between the ratios Load/CA and Ship/Load and a non-BIA forecast;

FIG. 10 is a graph showing the relationship between the forecast adjustment and the signal-to-noise ratio (SNR);

FIG. 11 is a graph, similar to FIG. 10, but showing that the point to be forecasted is not included in the fitting of the regression model; and

FIG. 12 is a block diagram of the system using CRAD for enhancing forecast accuracy with Load.

### DETAILED DESCRIPTION OF A PREFERRED EMBODIMENT OF THE INVENTION

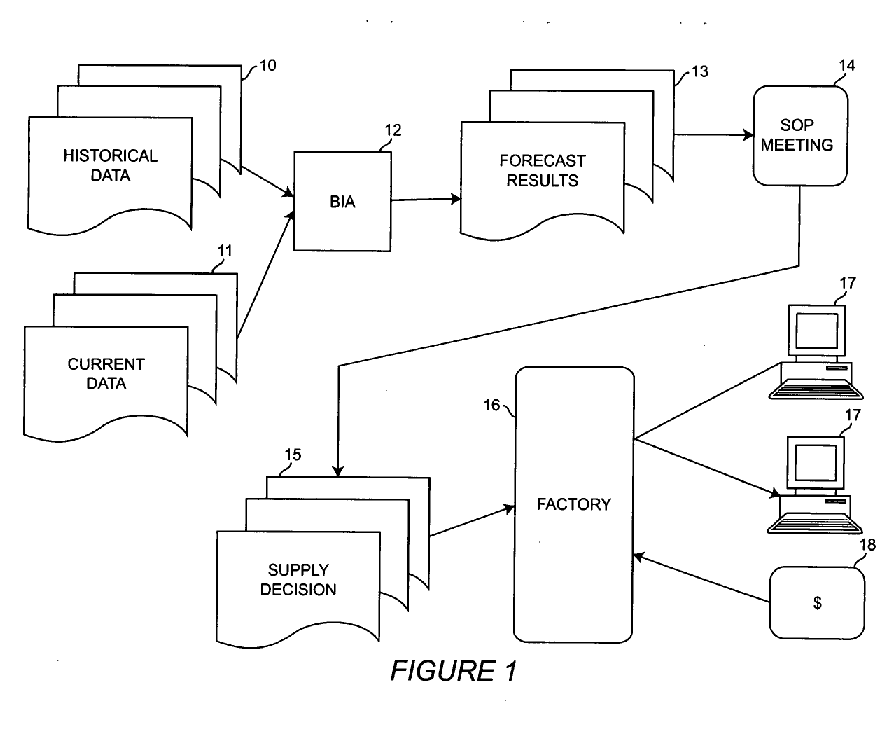

Referring now to the drawings, and more particularly to FIG. 1, there is shown the overall system diagram. There are two kinds of data. One is historical data 10 and the other, current data 11. For example, for load, historical data 10 refers to the load that occurs in the previous time periods or quarters. Current data 11, on the other hand, refers to the order that is for this present quarter where the forecast is to be made. BIA 12 takes the data input and produces the forecast output 13. Such output is fed to the supply decision high level executive meeting 14, called SOP meeting (Sales and Operations Meeting). The executives take into consideration the forecast 13 made by BIA 12 as well as other business information such as profit margin, product commonality, marketing campaigns, to make the final supply decision 15. Such decision drives the factory 16 and the supply chain in producing the products (e.g., computers 17) to satisfy the customer demand, which in turns brings back revenue 18 and profit to the business unit.

Without a good forecast, the executives would be blind in making supply decision. Supplying too much information results in scraps and excessive inventory. Supplying too little information results in lost revenue and customer satisfaction. Either way is detrimental to the vitality of the business. Making accurate forecast is crucial to the success of the business.

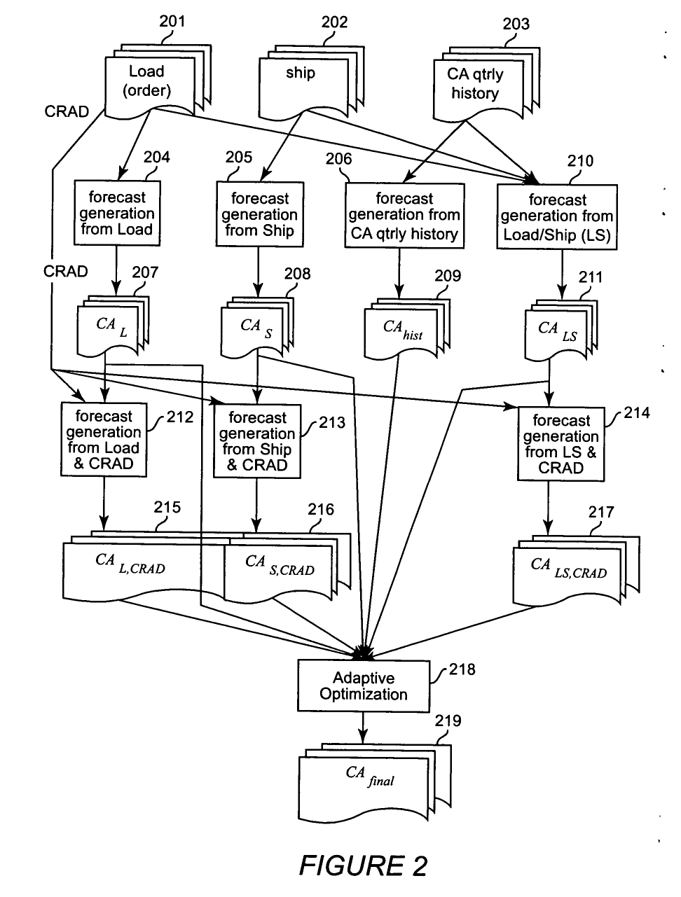

FIG. 2 shows the system functional diagram for the BIA 12 in FIG. 1. The data are classified into four sources (though the first two, Load and CRAD, are regarded as load related information). Load 201, Ship 202 and CA quarterly history 203 are each used to create respective forecasts 204, 205 and 206 based on the single indicator source information alone. By modeling the ratio of quarter-to-date load to quarter CA actual as a random variable with gamma distribution, the CA becomes a variable with generalized gamma distribution whose mean and sigma can be easily computed from the sample mean and sigma of the Load-to-CA ratio. The outputs generated by forecasts 204, 205 and 206 respectively are CA_{L} 207, CA_{S} 208 and CAₕᵢₛₜ 209. Load 201, Ship 202 and CA history 203 are used as a trio to support the generation of the forecast 210 called CA_{LS} 211. Because the Load to CA ratio exhibits significant uncertain and large sigma for its distribution from time to time, the estimator for CA_{LS} 211 makes use of a unique property not previously known anywhere that the ratio of Load-to-CA relates very well to the Ship-to-Load ratio. By estimating the functional relationship and the parameters relating these two ratios, BIA can predict the load-to-CA ratio with much less volatility or sigma, making use of the current Ship-to-Load ratio and the functional relationship relating the two ratios. Once the load-to-CA ratios are estimated with higher certainty, the final CA forecast can be produced with higher certainty also.

The next feature of the invention has to do with how the forecasts made by the above mentioned methods can be refined using the CRAD information. In FIG. 2, CA_{L} 207, CA_{S} 208 and CA_{LS} 211 are used for respective forecast generation and CRAD 212, 213 and 214. These, in turn, are used to refine the previous three forecasts as CA_{L,CRAD} 215, CA_{S,CRAD} 216 and CA_{LS,CRAD} 217, respectively. The key idea behind it is sometimes the order could be built up artificially (large quantity but weak). When such a situation occurs, generally more orders are requested to be shipped later than usual. By taking the log of the ratio of the mean over sigma for the distribution of the orders according to the dates the orders are to be shipped, such log signal-to-noise ratio (SNR) becomes a good predictor of the relative strengths of the demand. It predicts the relative offset of the forecast made by the previous methods (CA_{L}, CA_{S}, CA_{LS}) to create new forecasts (CA_{L,CRAD}, CA_{S,CRAD}, CA_{LS,CRAD). Such a predictor proves to be very valuable in improving forecast accuracy when applied to demand forecasting.}

The functional box 218 called “Adaptive Optimization” makes use of the seven forecast models created prior to that stage (CA_{L}, CA_{S}, CA_{LS}, CA_{L,CRAD}, CA_{S,CRAD}, CA_{LS,CRAD} and CAₕᵢₛₜ) and create a final optimum forecast 219. There are several keys to this function. One is that it picks the best forecast model specific to the geography and product group the forecast is to be applied to. This is very crucial to the success of the function. The second key is that it eliminates candidates depending on known properties according to how long the historical data are available and whether the time of forecast is early in the quarter, late in the quarter or not.

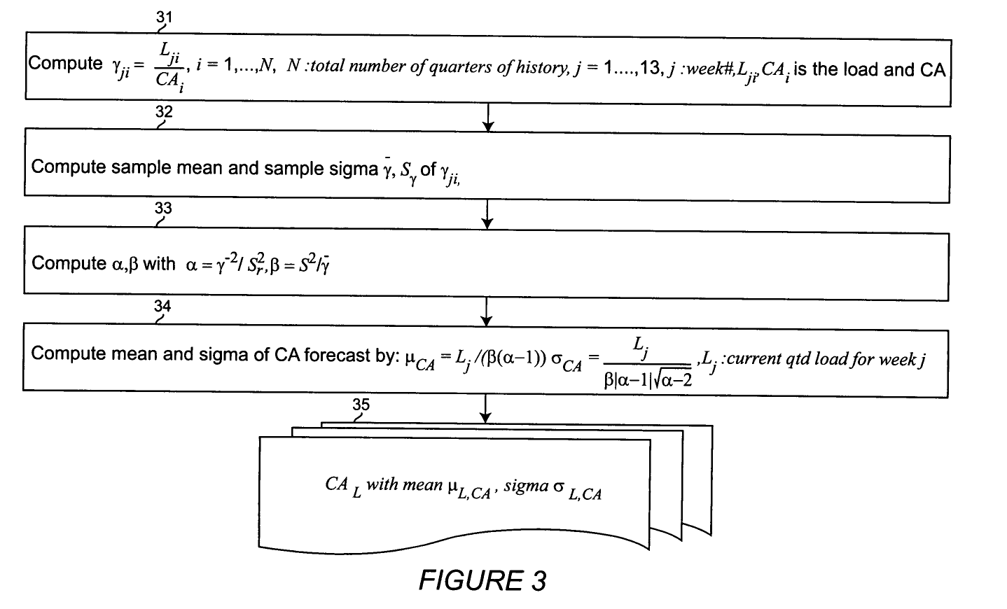

Forecast generation from Load 204 is performed as shown in the flow diagram of FIG. 3. In function block 31, the ratios of load to CA are formed for each of the historical quarter i at the same week j. Then in function block 32, the sample mean and sigma of the collection of history of the ratios are computed. If the load-to-CA ratio is modeled by a gamma distribution with parameters α, β, then the distribution for the final forecasted demand becomes a generalized gamma distribution. So, in function block 33, the two parameters α, β are estimated, and in function block 34, the mean and sigma of the generalized gamma distribution are estimated for the final forecasted CA demand.

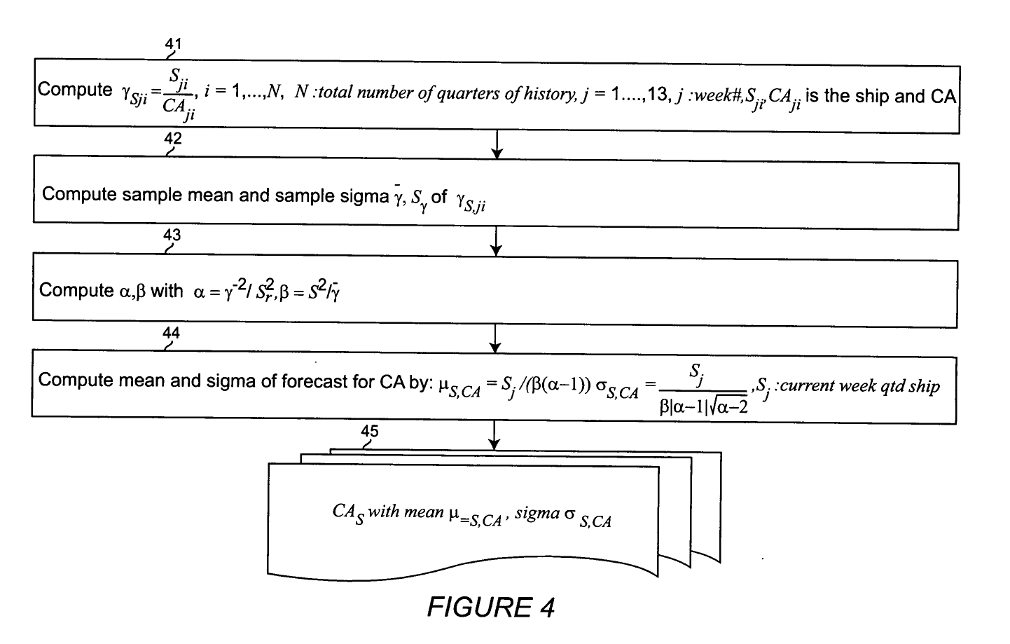

Forecast generation from Ship 205 is performed as shown in the flow diagram of FIG. 4. This process is very similar to the last function in FIG. 3. The only difference lies in the Lⱼᵢ in the numerator for the ratio in function block 31 (now function block 41) and the quarter-to-date current week load Lⱼ used in function block 34. They are changed to quarter-to-date ship Sⱼᵢ and the current week ship Sⱼ to compute the sample mean and sigma of the collection of history of the ratios.

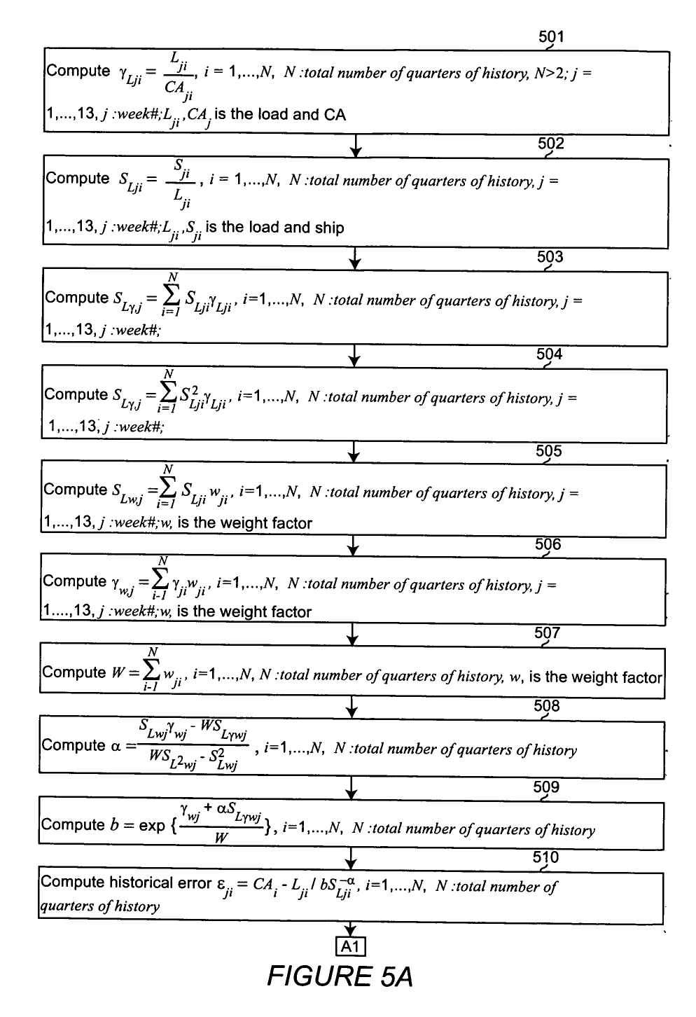

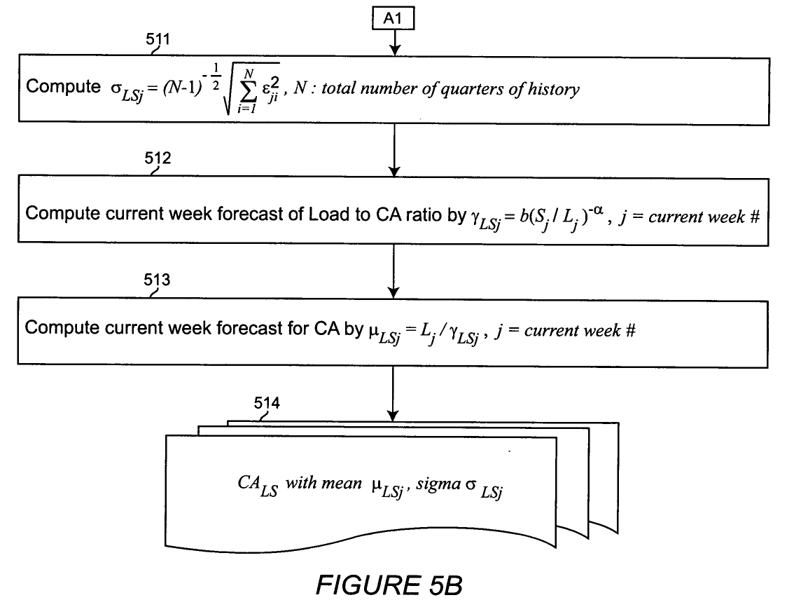

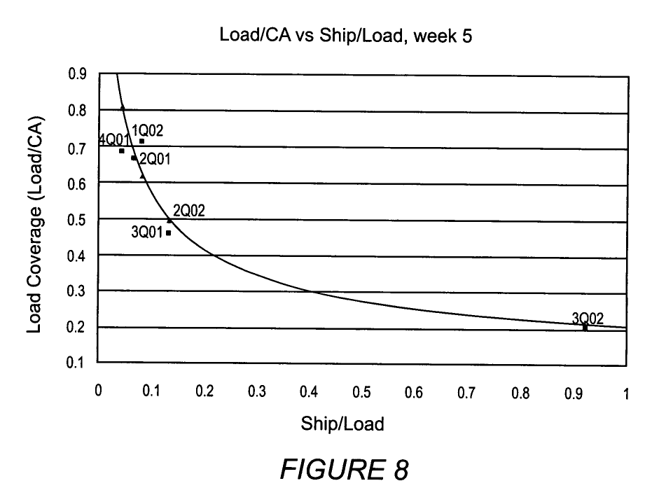

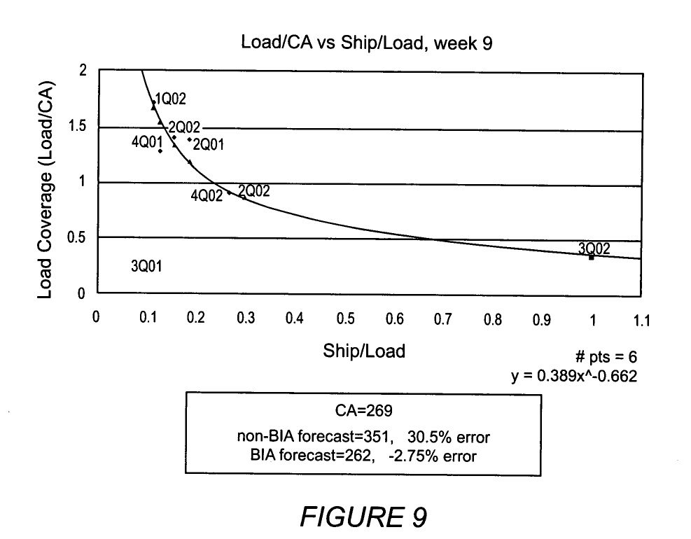

The forecast generation from Load/Ship (LS) 210 is performed as shown in the flow diagram of FIGS. 5A and 5B. This function in the invention exploits the relationship between the ratio load/CA and the ratio Ship/Load to refine the estimation of the distribution for the ratio load/CA, which in turn improves the uncertainty of the forecast for the final CA. FIGS. 8 and 9 illustrate the situation of using this relationship. FIG. 8 shows the situation of forecasting for 2Q2003 CA for a particular computer product. On the graph, the dot labeled 3Q02 shows the actual for the ratio of load to CA. If this height of this dot (which is the ratio of load to CA) in this graph can be estimated precisely, then the forecast for the quarter CA for 3Q2002 can also be estimated precisely (obviously, current load divided by this ratio gives the quarterly CA forecast). Without the fitted functional relationship from history, there is no other indication that would lead to the conclusion that 3Q02 load to CA ratio would be that low. Any model making use of history of this ratios would lead to a forecast of this ratio much higher than the actual (for example, the yellow line shows the weighted average of the ratios in history). This dramatically improves the forecast accuracy for this case. A similar situation is shown in FIG. 9, where a comparison of forecast to actual for CA is made between BIA and a non-BIA method commonly used.

Function block 501 in FIG. 5 is the same as function blocks 31 and 41 in FIGS. 3 and 4 for CA_{L} and CA_{S}, respectively. It creates the ratios of load to CA history collection. Function block 502 computes the corresponding ship-to-load ratio. Function blocks 503 to 507 compute the necessary quantities for determining the least square error estimate of the coefficients in the equation

$$\frac{L}{CA} = {b ( \frac{S}{L} )}^{- a} .$$

Function blocks 508 and 509 use these quantities to determine the parameters a, b. The derivations follow from setting up a series of equations like

$$\frac{{L}_{ji}}{{CA}_{i}} = {b ( \frac{{S}_{ji}}{{L}_{ji}} )}^{- a}$$

for the ith history quarter and jth week. Take the log of both sides and form the sum of square error of both sides. Taking derivatives of this sum of square error and equating it to zero gives the condition for the parameters a, b to minimize the sum of square error. The results are closed form minimum least square solution as shown in function blocks 508 and 509. Function block 510 uses the estimated coefficients to determine the model fit error ε, one for each historical data point. In function block 511 in FIG. 5B, the sample sigma for such error is computed, which is also the sigma for the final forecast error. In function block 512, the computed least square solution of the model parameters a, b is used to determine the estimated load to CA ratio, which in turn is used in function block 513 to determine the CA forecast using current week quarter to date load Lⱼ by dividing the load with the forecasted load to CA ratio. This output 514 is the forecast of CA using Load/Ship (LS).

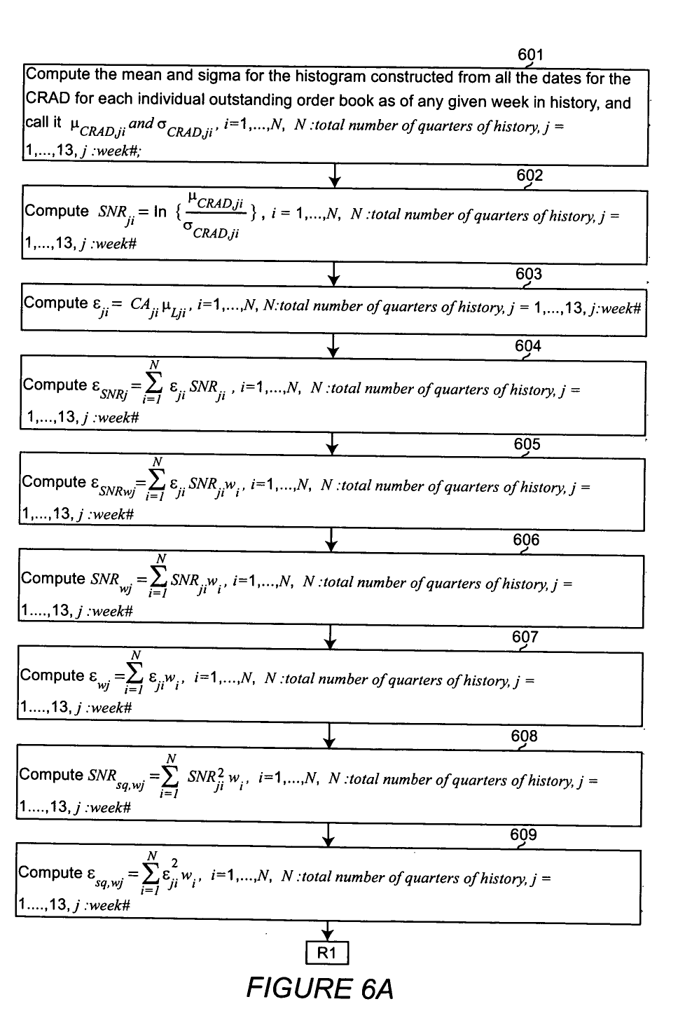

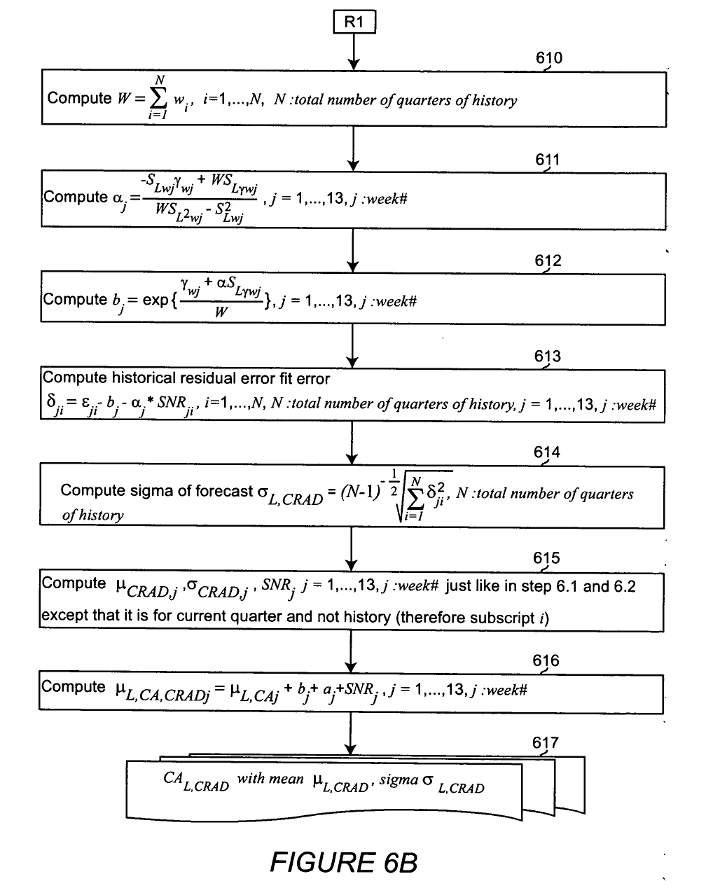

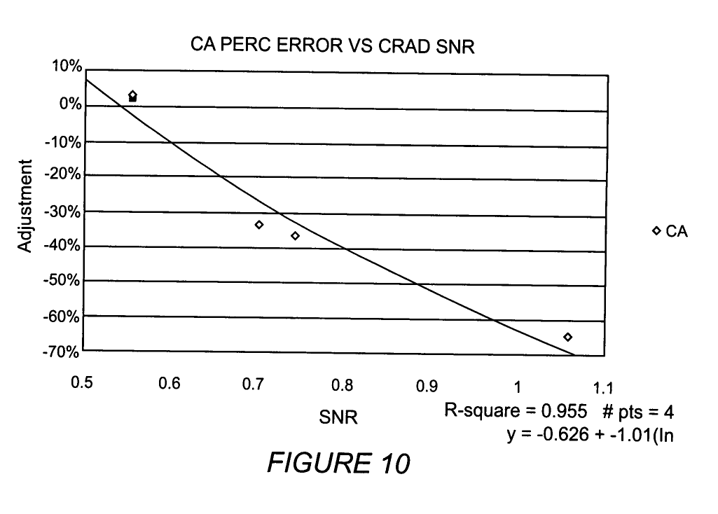

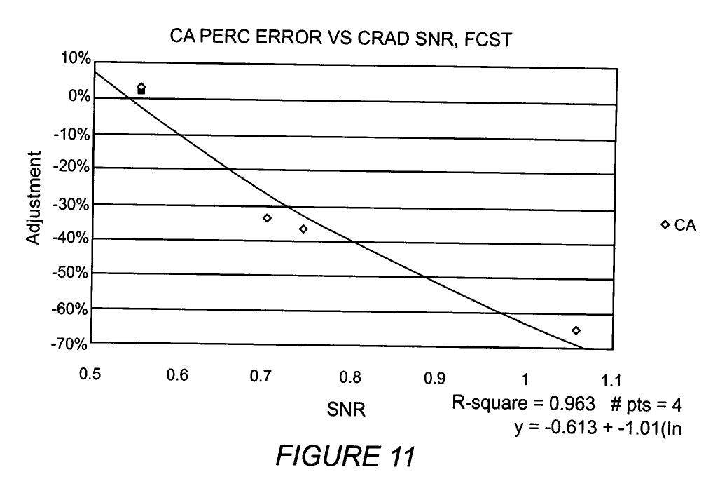

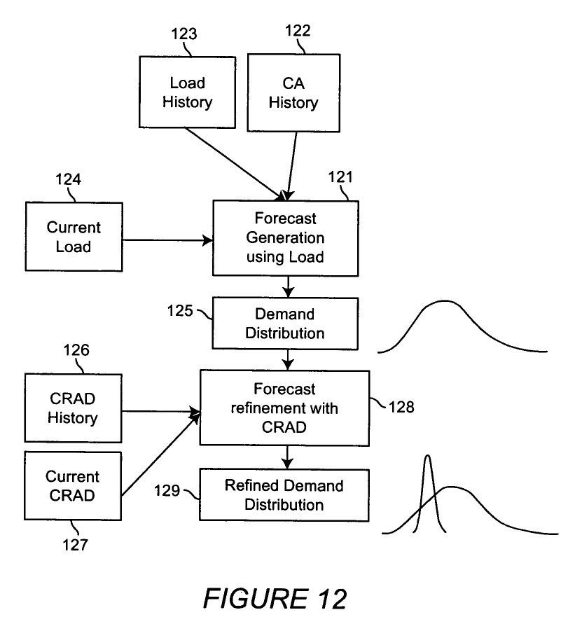

The forecast generation from Load and CRAD performed in function block 212 of FIG. 2 is shown in FIGS. 6A and 6B. This function in the invention exploits the relationship between the ratio load/CA and the statistical property of the CRAD for improving the forecast made by Load or Ship alone. The idea was triggered by the observation that when the orders are piling up but they are weak, the customer requested ship date (CRAD or RSD) generally is moved toward the end of the quarter just as a place holder. One reason this happens is that sales person often has a quota to make during the quarter (before the quarter ends). If the demand is weak and they have difficulty making the quota, some of them would ask the customer to place an order just as a place holder. But because the customer is not genuinely interested in buying, the order generally cannot be scheduled to be shipped soon. As a result, the CRAD or RSD date is set more toward the end of the quarter. Without using such information, an artificially built up high order would naturally result in a high forecast. The idea here is to use the degree with which the CRAD histogram shifts toward the end of the quarter as an indicator to determine how much the normal forecast should be scaled back due to artificially built up order. One way to do this is to explore the relationship between the adjustment or offset for the historical quarters where the actual data are already known, so that the amount of adjustment needed to bring a forecast to actual is known, and the degree of shift of the CRAD's histogram. FIG. 10 does exactly that. It is seen that the relationship is indeed present, with R-Square fit of 95.5%, and is log linear (if the SNR is the ratio of mean divided by the sigma of the CRAD histogram) or a linear function (if the SNR is the log of the ratio of mean divided by the sigma of the CRAD histogram), the adjustment needed can be predicted such that the forecast error is drastically reduced compared with the case where such adjustment is not made. FIG. 11 shows exactly that. For a particular product family, it is shown that three quarters of history (represented by three dots, not counting the third one starting from the left) were used to estimate the adjustment model (shown by green curve), and this model is used to predict a new quarter's demand. The third dot counting from the left is the actual adjustment needed for the new quarter whose demand is to be forecasted. From FIG. 11, it can be seen that with the fitted model, the forecast error can be reduced by more than 35%, a huge amount. FIG. 12 is another way to look at the system function of the CRAD method.

Now the method and the procedure shown in FIGS. 6A and 6B for this CRAD methodology will be explained. In function block 601 in FIG. 6A, the mean and sigma of the histogram are computed of all the orders with CRAD dates as the horizontal axis. This is done for every quarter i in history and every week j. In function block 602, the SNR is computed. Note that the log is taken. When the log is taken, the regression model in FIG. 10 becomes a linear rather than a log linear function. In function block 603, the adjustment needed to bring a normal forecast based on load to the actual for each of the historical quarter i and week j is computed. In function blocks 604 to 610 (continuing to FIG. 6B), the necessary quantities for determining the least square error estimate of the coefficients in the equation εⱼᵢ=bⱼ+a_{jSNR}_{ⱼᵢ} are computed, where εⱼᵢ is the adjustment on the normal forecast needed to take into consideration the weakness of the order as shown in function block 603. In function blocks 611 and 612 in FIG. 6B, these quantities are used to determine the parameters aⱼ, bⱼ. The derivations follow from setting up a series of equations like εⱼᵢ=bⱼ+a_{jSNR}_{ⱼᵢ} for the ith history quarter and jth week. Form the sum of square error of both sides algebraically. Taking derivatives of this sum of square error and equating it to zero gives the condition for aⱼ, bⱼ to satisfy to minimize the sum of square error. The results are the closed form minimum least square solution determined in function blocks 611 and 612. Function block 613 uses the estimated coefficients to determine the model fit error for the adjustment model δ, one for each historical data point. In function block 614, the sample sigma for such error is computed, which is also the sigma for the final forecast error. In function block 615, the SNR is computed for the current quarter using the current mean and sigma for the current CRAD distribution. Function block 616 uses the computed least square solution of the model parameters aⱼ, bⱼ to determine the estimated adjustment needed, and add it to the μ_{L,CAj}, which is the forecast made by using only the load and CA information in FIG. 3. This completes the forecast of CA using Load and CRAD information.

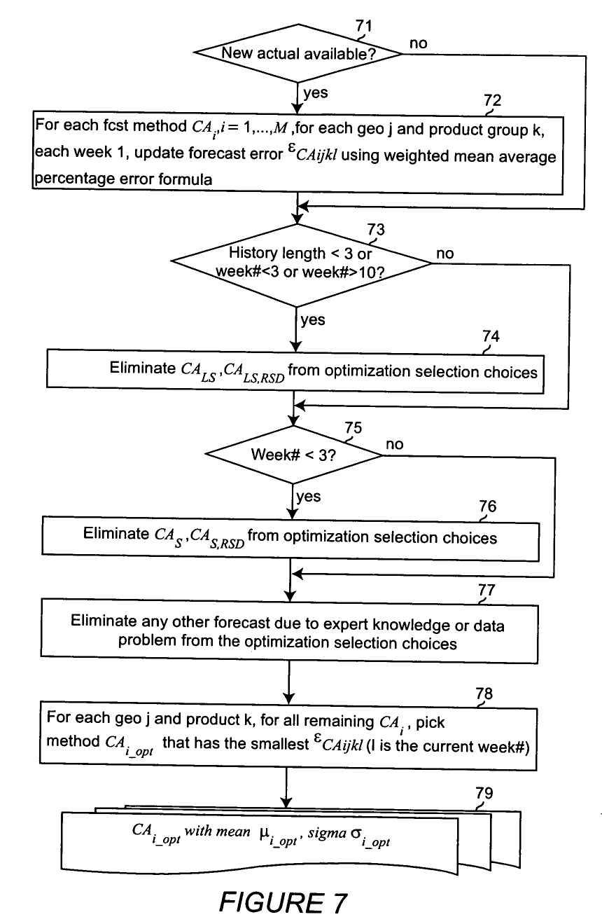

The adaptive optimization 218 in FIG. 2 is shown in FIG. 7. The function in FIG. 7 is the last function of the process. Before the start of the function, seven forecasting outputs are directed to it. They are CA_{L}, CA_{S}, CA_{LS}, CA_{L,CRAD}, CA_{S,CRAD}, CA_{LS,CRAD}, and CAₕᵢₛₜ. The goal is create a final optimum forecast. There are several keys to this function. One is that it picks the best forecast model specific to the geography and product group to which the forecast is to be applied. This is very crucial to the success of the function. The second key is that it eliminates candidates depending on known properties according to how long the historical data are available and whether the time of forecast is early in the quarter, late in the quarter or not.

A determination is made in decision block 71 as to whether a new quarter has just arrived and the actual for the old quarter just became available. If so, then decision block 71 will direct the process to go to function block 72 to update the forecast error performance metric ε_{CAijk} that is maintained for each geographic region j, each product group k and each week i. Decision block 73 will bypass the LS forecasting method in function block 74 if the historical length is shorter than three or if the current week is still early in the quarter or very late in the quarter. Because the LS model fits a power regression with two parameters, it is essential to have at least three points of history so as not to overfit. Furthermore, when it is very early in the quarter, the ship is too small to make the LS work effectively. Similarly, decision block 75 will direct the system to bypass any forecast made in function block 76 with only ship if the week number is less than two, because the ship usually starts building up much later than load and is more prone to error. In function block 77, any method from the candidate lists based on any information not available to the model is eliminated, based on human judgement. In function block 78, a search is made among the remaining candidates (for each geographic region, product grouping and for the current week) for the one that has the smallest mean average percent error based on weighted historical performances. The candidate that is picked will be the one chosen as the final forecast in output 79.

FIG. 12 summarizes the invention. Forecast generation 121 is first performed using CAₕᵢₛₜ 122, Load history 123 and current Load 124. Then, using the log mean to sigma ratio of the CRAD distribution 125, the CRAD history 126 and the current CRAD 127, the forecasts are refined at 128 to arrive at more accurate forecasts. Using adaptive optimization, a final optimal forecast is selected at 129.

Best Indicator Adaptive (BIA) method is significant both in terms of theoretical foundations and practical impact and implications. The common theme and unifying theory of the power of quotient, and the methods of making use of order composition and sales opportunities pipeline progression as well as the methodology and theoretical analysis of the CA Quarter History indicator, and the adaptive optimization framework, are all key contributors.

While the invention has been described in terms of a single preferred embodiment, those skilled in the art will recognize that the invention can be practiced with modification within the spirit and scope of the appended claims.

1. A computer implemented best indicator adaptive method for demand forecasting comprising the steps of:
implementing a plurality of forecasting subsystems which make use of one or more different indicators;
generating forecasts based on one or more of said indicators;
refining the forecasts based on distribution demand; and
selecting a single composite forecast model for demand forecasting of a product.

2. The computer implemented method recited in claim 1, wherein the different indicators used by the plurality of forecasting subsystems include Load (L), Ship (S) and Customer Acceptances history (CAₕᵢₛₜ).

3. The computer implemented method recited in claim 2, wherein the step of generating forecasts includes the steps of:
generating a forecast from Load (L);
generating a forecast from Ship (S);
generating a forecast from Load and Ship (LS); and
generating a forecast from Customer Acceptances history (CAₕᵢₛₜ).

4. The computer implemented method recited in claim 3, wherein the step of refining the forecasts based on distribution demand using Customer Requested Date (CRAD) and includes the steps of:
generating a forecast from Load (L) and CRAD as CA_{L,CRAD};
generating a forecast from Ship (S) and CRAD as CA_{S,CRAD}; and
generating a forecast from Load (L) and Ship (S) as CA_{LS,CRAD}.

5. The computer implemented method recited in claim 4, wherein the step of selecting a single composite forecast model for demand forecasting of a product includes the steps of:
for each forecast CA_{L}, CA_{S}, CA_{LS}, CA_{L,CRAD}, CA_{S,CRAD}, CA_{LS,CRAD} and CAₕᵢₛₜ, determining a forecast error;
eliminating CA_{LS} and CA_{LS,CRAD} if data is for a historical period shorter than a predetermined period;
eliminating any other forecast due to expert knowledge;
for all remaining forecasts, selecting a forecast having a smallest error; and
outputting a selected forecast as an optimum forecast.

6. A computer implemented best indicator adaptive method for demand forecasting comprising the steps of:
implementing a plurality of forecasting subsystems making use of single, double or triple sets of four sources of information, Load (L), Ship (S), Customer Acceptances (CA), and Customer Request Date (CRAD);
forecasting Customer Acceptances (CA) based on Load (L) to generate CA_{L};
forecasting Customer Acceptances (CA) based on Ship (S) to generate CA_{S};
forecasting Customer Acceptances (CA) based on Load (L), Ship (S) and Customer Acceptances history (CAₕᵢₛₜ) to generate CA_{LS};
using a log mean to sigma ratio of CRAD distribution, adjusting the forecasts CA_{L}, CA_{S} and CA_{L,S} to arrive at more accurate forecasts CA_{L,CRAD}, CA_{S,CRAD}, and CA_{LS,CRAD}; and
using adaptive optimization, selecting a final optimum forecast with a smallest mean average percent historical error specific to geography and product grouping while eliminating candidates based on dependency of forecast error of individual candidates on length of historical data.

7. The computer implemented method recited in claim 6, wherein the step of selecting a final optimum forecast includes the steps of:
for each forecast CA_{L}, CA_{S}, CA_{LS}, CA_{L,CRAD}, CA_{S,CRAD}, CA_{LS,CRAD}, and CAₕᵢₛₜ, determining a forecast error;
eliminating CA_{LS} and CA_{LS,CRAD} if data is for a historical period shorter than a predetermined period;
eliminating any other forecast due to expert knowledge;
for all remaining forecasts, selecting a forecast having a smallest error; and
outputting a selected forecast as an optimum forecast.
